(19) United States
(12) Patent Application Publication
(10) Pub. No.: US 2012/0199621 A1
(43) Pub. Date: Aug. 9, 2012

(54) APPARATUS FOR MOUNTING A MEDIA DEVICE IN A VEHICLE

(76) Inventor: Young-June YOON, Seoul (KR)

(21) Appl. No.: 13/368,194

(22) Filed: Feb. 7, 2012

(30) Foreign Application Priority Data
Feb. 8, 2011 (KR) 10-2011-0010988

(51) Int. Cl. B60R 7/06

(52) U.S. Cl. 224/483

(57) ABSTRACT

An apparatus for mounting a media device in a vehicle. First and second support members are rotatably connected to each other. A device holding member, which allows a media device to be affixed thereto, is disposed between the first and second support members. A fixing support member supports the first and second support members by opening them. The first and second support members are sandwiched and firmly mounted between the dashboard and the front windshield of the vehicle.

### CROSS REFERENCE TO RELATED APPLICATION(S)

This application claims the benefit of Korean Patent Application No. 10-2011-0010988, filed Feb. 8, 2011, which is hereby incorporated by reference in its entirety into this application.

### BACKGROUND OF THE INVENTION

1. Technical Field

The present invention relates, in general, to an apparatus for mounting a media device in a vehicle and, more particularly, to a mount on which a media device, such as a navigator, a portable media player (PMP), or a smart phone, which can be used in a vehicle, can be simply mounted.

2. Description of the Related Art

In general, media devices are used when watching an image or listening to a music or radio program. Recently, the distribution of portable devices that can be readily carried by users has been greatly increasing.

Portable media devices include an MP3 player, a portable multimedia player (PMP), a smart phone, a tablet PC and etc. In addition, navigators are devices provided inside a vehicle in order to instruct a driver about the course to a destination.

In response to the increased distribution of portable media devices as described above, there is an increasing desire to use such portable media devices in a vehicle. For this, a media device such as a portable media device or a navigator is affixed to a separate mount when it is used in a vehicle.

A media device mount for a vehicle is fixed to the front windshield of the vehicle using a suction disk or to a dashboard using an adhesive sheet, such as double-sided tape, a bolt or the like.

However, this structure in which the media device mount for a vehicle is fixed to the front windshield of the vehicle using the suction disk has problems in that the media device mount obstructs the vision of the driver when driving, and thus becomes an obstacle to safe driving, and that marks remain on the portion of the front windshield of the vehicle on which the suction disk was attached when the media device mount is detached from the windshield. Furthermore, the force of suction that attaches the media device mount is easily released because of the weight of the media device, and thus the media device mount is easily dislodged from the place to which it is attached.

In particular, in the structure in which the media device mount for a vehicle is fixed to the front windshield of the vehicle using the suction disk, the suction ability of the suction disk deteriorates in the winter, and thus the media device mount which is attached by suction is easily released due to the weight of the media device. This may cause the danger of a traffic accident occurring during driving and the affixed media device being damaged.

In addition, the structure in which the media device mount for a vehicle is fixed to the dashboard using an adhesive sheet or a fastening tool, such as a bolt, causes a mark to be left behind on the dashboard by the adhesive sheet or leaves behind a fastening hole for the bolt, thereby degrading the aesthetics of the vehicle. Due to such problems, drivers are reluctant to attach or detach a media device using such a mount.

### SUMMARY OF THE INVENTION

Accordingly, the present invention has been made keeping in mind the above problems occurring in the prior art, and an object of the present invention is to provide an apparatus for mounting a media device in a vehicle, which is freely attachable and detachable and is firmly fixed to the interior of the vehicle.

In order to accomplish the above object, the present invention provides an apparatus for mounting a media device in a vehicle that includes a first support member supported on an upper surface of a dashboard of the vehicle; a second support member rotatably connected to the first support member, the second support member being supported on an inner surface of a front windshield of the vehicle; a fixing support member that increases an interval between the first and second support members so that the first and second support members are fixed between the dashboard and the front windshield of the vehicle; and a device holding member disposed between the first and second support members for mounting the media device.

According to embodiments of the invention, an apparatus for mounting a media device in a vehicle can be sandwiched and firmly fixed between the dashboard and the front windshield of the vehicle, so that the media device can be simply and securely affixed to the media device mount inside the vehicle.

In addition, an apparatus for mounting a media device in a vehicle prevents the unnecessary formation of marks on the inside of the vehicle when the media device is affixed thereto, and enables a variety of media devices to be simply affixed thereto.

Furthermore, an apparatus for mounting a media device in a vehicle minimizes the portion of the front windshield of the vehicle that is concealed thereby, thereby improving the vision of the driver.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the usage of an apparatus for mounting a media device in a vehicle of the present invention;

FIG. 2 is a perspective view showing an apparatus for mounting a media device in a vehicle according to an exemplary embodiment of the present invention;

FIG. 3 is a configuration view showing the operation of the apparatus for mounting a media device in a vehicle shown in FIG. 2;

FIG. 4 is a perspective view showing an apparatus for mounting a media device in a vehicle according to another embodiment of the present invention;

FIG. 5 is a configuration view showing the operation of the apparatus for mounting a media device in a vehicle shown in FIG. 4;

FIG. 6 is an exploded perspective view showing an apparatus for mounting a media device in a vehicle according to a further embodiment of the present invention;

FIG. 7 and FIG. 8 are example views showing the operation of the apparatus for mounting a media device in a vehicle shown in FIG. 6;

FIG. 9 is a cross-sectional view showing an apparatus for mounting a media device in a vehicle according to a still another embodiment of the present invention.

### DESCRIPTION OF THE PREFERRED EMBODIMENTS

Reference now should be made to the different drawings, through which the same reference numerals are used to designate the same or similar components.

Hereinafter exemplary embodiments of the invention will be described in detail with reference to the accompanying drawings.

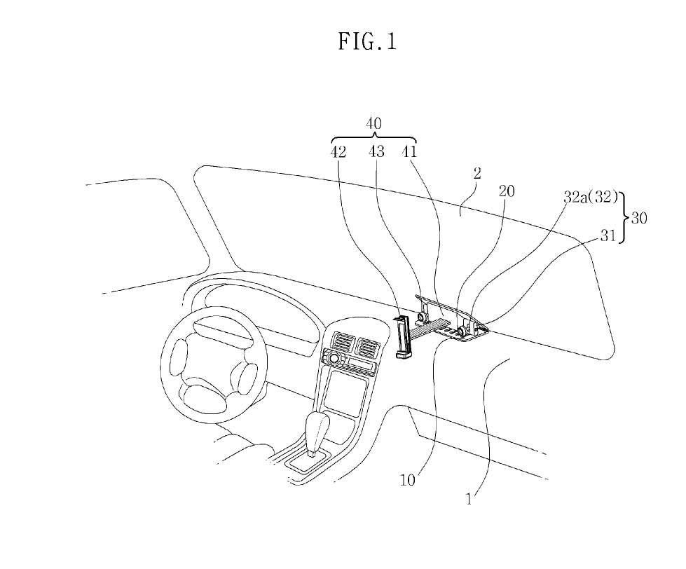

Referring to FIG. 1, a media device mount for a vehicle according to an exemplary embodiment of the invention includes a first support member 10, and a second support member 20 which are fixedly inserted between a dashboard 1 of the vehicle and the inner surface of the front windshield 2 of the vehicle, and a device holding member 40, which is disposed between the first support member 10 and the second support member 20, such that a media device can be affixed to the device holding member 40.

The first support member 10 is supported on the upper surface of the dashboard 1 of the vehicle, and the second support member 20 is rotatably connected to the first support member 10 and is supported on the inner surface of the front windshield 2 of the vehicle.

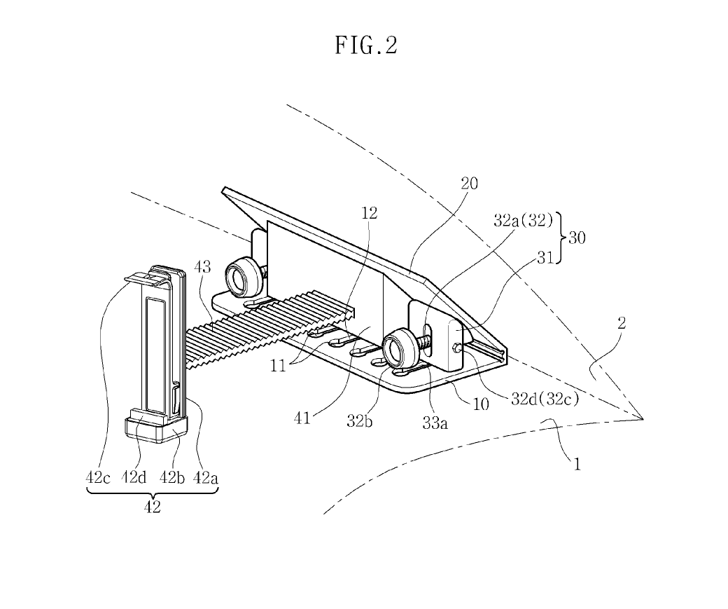

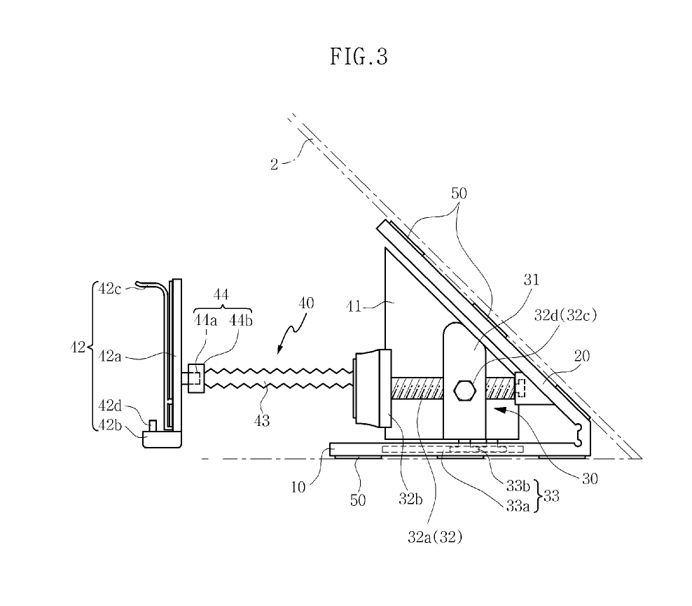

Referring to FIG. 2 and FIG. 3, the first support member 10 and the second support member 20 may be integrally connected to each other such that they may rotate about each other.

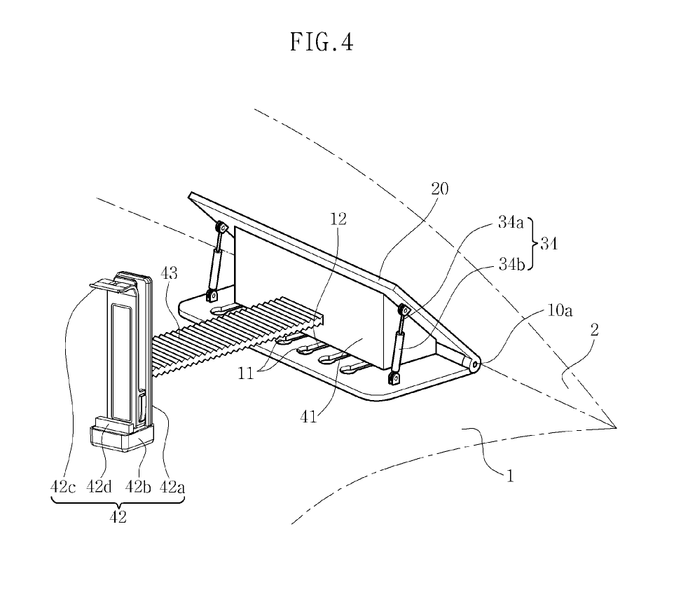

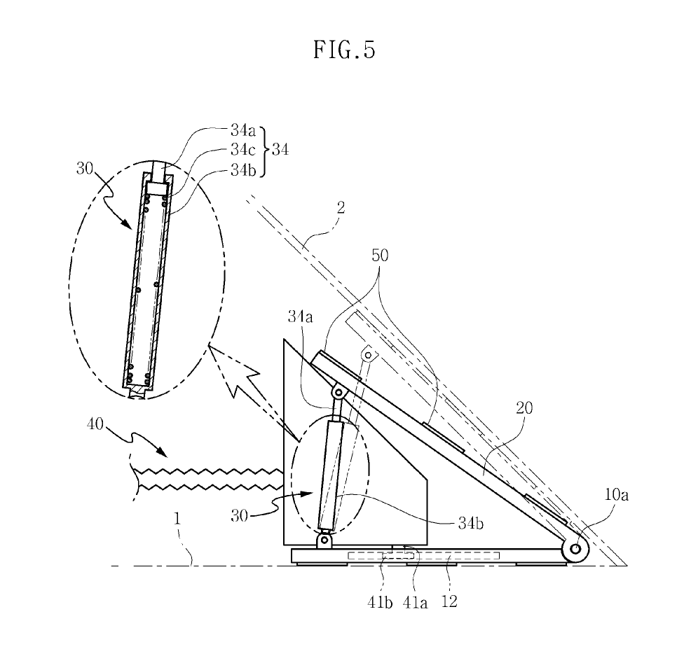

In addition, referring to FIG. 4 and FIG. 5, the embodiment of the structure of the first support member 10 and the second support member 20 may include a hinge shaft 10a, which extends through the joint between the first support member 10 and the second support member 20, such that the structure is rotatable about the hinge shaft 10a.

It should be understood that the structure in which the first support member 10 and the second support member 20 are connected to each other can be variously modified into other structures in which the support members are rotatably connected to each other.

In addition, the media device mount for a vehicle according to embodiments of the invention also includes a fixing support member 30, which increases the interval between the first and second support members 10 and 20 such that the first and second support members 10 and 20 are fixed between the dashboard 1 of the vehicle and the front windshield 2 of the vehicle.

Referring to FIG. 2, the fixing support member 30 includes a movable block 31, which is disposed between the first and second support members 10 and 20 such that it is displaceable back and forth and supports the interval between the first and second support members 10 and 20.

The fixing support member 30 also includes a displacing section 32, which displaces the movable block 31 back and forth between the first and second support members 10 and 20.

It is preferred that the movable block 31 have an inclined surface, which is abutted at an incline to the inner surface of the second support member 20.

The displacing section 32 may be implemented as a displacing screw 32a, which is rotatable, extends in the direction in which the displaceable block 31 is displaced, and is screwed into the movable block 31, such that it displaces the movable block 31 back and forth depending on the direction of rotation.

The leading end of the displacing screw 32a is rotatably connected to the inner surface of the second support member 20, and the movable block 31 is supported on the upper surface of the first support member 10 such that it is displaced back and forth.

The displacing screw 32a is preferably provided with a manipulation handle 32b, such that a user can easily manipulate the displacing screw 32a by grasping the manipulation handle 32b.

It is preferred that the fixing support member 30 also include a block guide 33, which guides the movement of the movable block 31.

The block guide 33 has a guide groove 33a formed in the first support member 10, the guide groove 33a extending in the direction in which the movable block 31 is displaced, and a guide protrusion 33b protruding from the lower surface of the movable block 31, the guide protrusion 33b being movably coupled to the guide groove 33a.

Although not shown, the block guide 33 may include a rail groove formed in the lower surface of the movable block 31 and a guide rail protruding from the first support member 10, the guide rail extending in the direction in which the movable block 31 is displaced and being movably inserted into the rail groove.

It should be understood that the block guide 33 may be embodied in a variety of modifications that can guide the movement of the movable block in a straight line.

In an example, a movable screw 32a is fixed by the force that is generated when the first and second support members 10 and 20 are tightly sandwiched and are elastically supported between the upper surface of the dashboard 1 and the front windshield of the vehicle, and can be rotated only by the application of force.

It is preferred that the movable section 32 also include a locking section 32c, which locks or unlocks the displacing screw 32a so that it can or cannot rotate.

The locking section 32c prevents the displacing screw 32a from rotating in the state in which the position of the movable block 31 is fixed, so that the first and second support members 10 and 20 remain in the firmly fixed state in which they are sandwiched between the upper surface of the dashboard 1 and the front windshield 2 of the vehicle. In an example, the locking section 32c is a fixing nut (not shown), which is meshed with the displacing screw 32a such that it presses and fixes the movable block 31. It should be understood that the locking section 32c may be a fixing bolt 32d, which extends through the movable block 31 and presses the displacing screw 32a, or may be modified into a variety of examples that can lock or unlock the displacing screw 32a such that it can or cannot rotate.

Referring to FIG. 3, the movable block 31 is displaced forth in response to the rotation of the displacing screw 32a so that it opens and supports the first and second support members 10 and 20.

In response to the displacement of the movable block 31, the portions of the first and second support members 10 and 20 that are opposite to the joint are opened so that the first and second support members 10 and 20 are firmly sandwiched and fixed between the upper surface of the dashboard 1 and the front windshield 2 of the vehicle.

The apparatus for mounting a media device in a vehicle according to embodiments of the invention may also include an elastic member 50 disposed on the lower surface of the first support member 10, i.e. the lower surface of the first support member 10 that is supported on the upper surface of the dashboard 1 of the vehicle, or the outer surface of the second support member 20. The outer surface of the second support member 20 is the port that is supported on the inner surface of the front windshield 2 of the vehicle.

The elastic member 50 is provided on at least one of the lower surface of the first support member 10 and the upper surface of the second support member 20. Preferably, an elastic member 50 is provided separately of the lower surface of the first support member 10 and the upper surface of the second support member 20.

When the first support member 10 is supported on the upper surface of the dashboard 1 and the second support member 20 is supported on the front windshield 2 of the vehicle, the elastic members 50 are compressed between the first support member 10 and the upper surface of the dashboard 1 and between the second support member 20 front windshield 2 of the vehicle, respectively, thereby increasing the fixing force of the first and second support members 10 and 20. The elastic members 50 help the first and second support members 10 and 20 be firmly fixed between the upper surface of the dashboard 1 and the front windshield 2 of the vehicle. In addition, they absorb vibration and impact that occur while the vehicle is being driven, thereby preventing noise from being generated when driving.

Referring to FIG. 4 and FIG. 5, the fixing support member 30 includes an elastic support section 34, which provides an elastic support between the first and second support members 10 and 20, so that the first and second support members 10 and 20 are sandwiched and fixed between the dashboard 1 and the front windshield 2 of the vehicle. The elastic support section 34 may be implemented as a spring that has one end connected to the first support member 10 and the other end connected to the support member 20.

In addition, the elastic support section 34 may include a support bar 34a, which is hinged to one of the first support member 10 and the second support member 20.

The elastic support section 34 may also include a movable guide bar 34b, which is disposed between first support member 10 and the second support member 20, is hinged to the other one of the first support member 10 and the second support member 20, and is movably coupled to the support bar 34a.

The elastic support section 34 may also include a support spring 34c, which is provided on the movable guide bar 34b and elastically supports the support bar 34a.

As shown in FIG. 5, the elastic support section 34 elastically supports the interval between the first support member 10 and the second support member 20, thereby fixing the first support member 10 and the second support member 20 between the dashboard 1 and the front windshield 2 of the vehicle.

It should be understood that the fixing support member 30 may be embodied in a variety of modifications that can open the interval between the first support member 10 and the second support member 20 so that the first support member 10 and the second support member 20 are sandwiched and fixed between the dashboard 1 and the front windshield 2 of the vehicle.

According to embodiments of the invention, the device holding member 40 is disposed between the first and second support members 10 and 20, such that a media device can be affixed thereto.

The device holding member 40 includes a fixing section 41, which is detachably disposed between the first and second support members 10 and 20.

The device holding member 40 also includes a holding section 42, which is provided on the fixing section 41, such that it can hold a media device.

The holding section 42 is provided on the front surface of the fixing section 41 that faces the driver, and is fabricated in a variety of structures that can hold a media device having a variety of structures and shapes.

In embodiments of the invention, the device holding member 40 can be individually singled out and changed to suit the type of media device that is to be affixed thereto.

It is preferred that the device holding member 40 also include a connecting bar 43, which is connected to the front surface of the fixing section 41 that faces the driver. The connecting bar 43 is bendable, and the holding section 42 is provided on one end thereof.

The holding section 42 includes a base body 42a connected to the connecting bar 43.

The holding section 42 also includes a first clamping section 42b and a second clamping section 42c, which are provided on the base body 42a. The first and second clamping sections 42b and 42c are spaced apart from each other by a predetermined yet adjustable interval.

At least one of the first and second clamping sections 42b and 42c is movably provided and elastically supported on the base body 42a.

The media device is held by an elastic force between the first and second clamping sections 42b and 42c.

It is preferred that a terminal 42d, which is connected to a terminal of the media device, be provided on at least one of the first and second clamping sections 42b and 42c.

The terminal 42d includes a power terminal and a control terminal, which can control the operation. With this configuration, power can be supplied to the media device placed inside the vehicle so that it can be continuously used, and the driver can easily operate the media device.

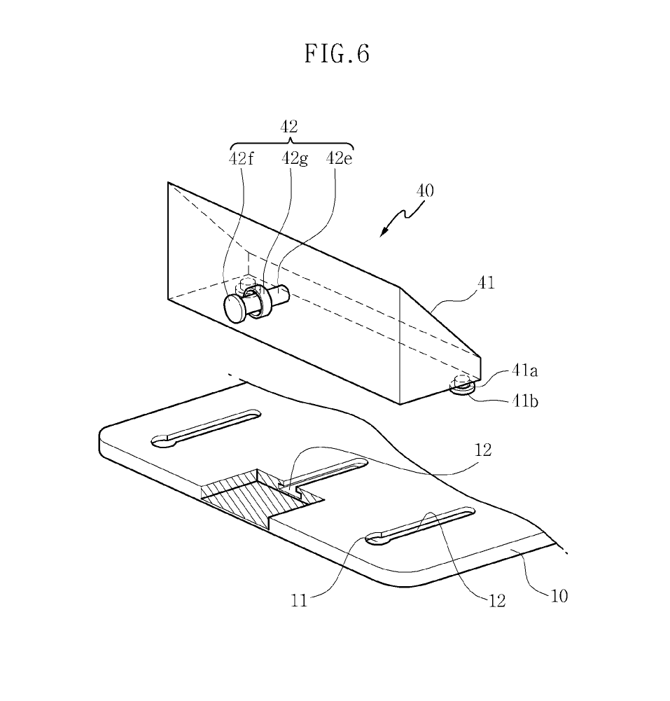

Referring to FIG. 6, the holding section 42 may include a holding bar 42e protruding from the front surface of the fixing section 41 that faces the driver. A coupling section 42f, which is intended to be detachably coupled to the media device, is provided on one end of the holding bar 42e.

The holding section 42 may also include a fixing section 42g, which locks or unlocks the media device so that it is coupled to or decoupled from the coupling section 42f of the holding bar 42e.

Although not shown, the holding section 42 may be modified such that it is provided with a pair of grasping sections on the front surface of the fixing section 41 that faces the driver, the interval between the grasping sections being adjustable, so that the multimedia device can be directly held on the front surface of the fixing section 41. It should be understood that the holding section 42 can be modified into any structure that can fixedly hold the media device.

Referring to FIG. 3, the device holding member 40 preferably includes a device rotating section 44, which connects the holding section 42 on the front surface of the fixing section 41, such that the holding section 42 is rotatable and the orientation of the screen of the media device can be adjusted.

The device rotating section 44 includes a rotary shaft 44a, which is provided on one of the holding section 42 and the fixing section 41, and a shaft support section 44b, which is provided on the other one of the holding section 42 and the fixing section 41. The rotary shaft 44a is rotatably coupled to the shaft support section 44b. The rotary shaft 44a is press fitted into the shaft support section 44b. With this configuration, the holding section 42 is rotated only when an intended force is applied thereto, but is firmly fixed in position when a force is not applied thereto.

When the media device is held on the holding device 42, it is possible to freely adjust the orientation of the screen of the media device by rotating the holding section 42.

In an example, the rotary shaft 44a protrudes from the rear surface of the base body 42a, and the shaft support section 44b is provided on one end of the connecting bar 43.

Referring to FIG. 6, it is preferred that the fixing section 41 be provided such that it is displaceable back and forth between the first and second support members 10 and 20. The position of the media device can be freely adjusted by displacing the fixing section 41 in the forward and backward directions of the vehicle.

The fixing section 41 is provided at the lower portion thereof with protrusions 41a, each of which has a holding rib 41b on the outer surface of one end thereof. The first support member 10 is provided with receiving sections 11 such that one end of each protrusion 41a is inserted into a respective receiving section 11. A displaceable receiving section 12 is connected to the receiving section 11 and has a linear shape that extends in the forward or backward directions, such that the protrusion 41a can be displaced back and forth therein, with the holding rib 41b remaining in the state in which it is held in the upward direction when the protrusion 41a is being displaced.

In this configuration, the fixing section 41 is displaceable in the lengthwise direction and its position is adjustable in the state of the protrusion 41a being inserted into the receiving section 11, and can be freely engaged to and disengaged from the first support member 10 using the receiving section 11.

In an example, one side of the fixing section 41 forms an inclined surface, and the fixing section 41 is sandwiched and fixed between the first and second support members 10 and 20. One side of the fixing section 41 faces the second support member 20.

Here, when the first and second support members 10 and 20 are sandwiched and fixed between the dashboard 1 and the front windshield 2 of the vehicle, the position of the fixing section 41 is fixed by pressing it between the first and second support members 10 and 20.

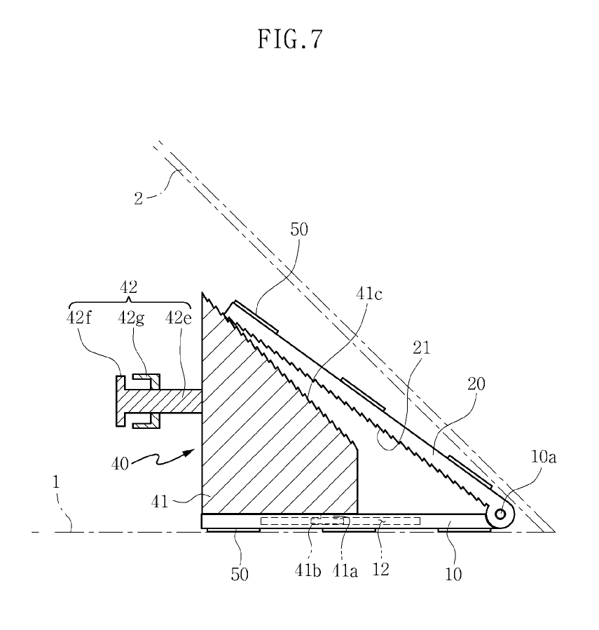

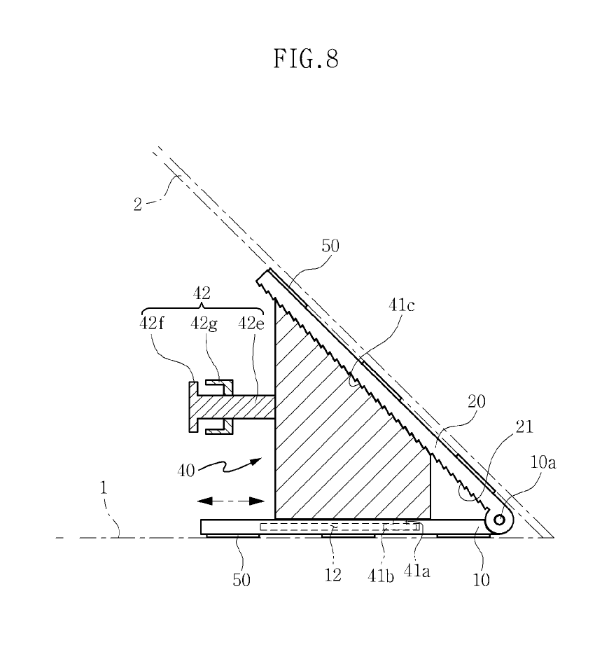

Referring to FIG. 7 and FIG. 8, the second support member 20 is preferably provided on the inner surface thereof with a plurality of first teeth 21, which catches and fixes one end of the fixing section 41.

It is more preferable that the fixing section 41be provided on the inclined surface thereof with a plurality of second teeth 41c, which mesh with the first teeth 21.

With this configuration, when the first and second support members 10 and 20 are sandwiched and fixed between the dashboard 1 and the front windshield 2 of the vehicle, the fixing section 41 is firmly fixed in position, since at least one of the first teeth 21 of the second support member 20 is engaged with at least one of the second teeth 41c.

When the first and second support members 10 and 20 are sandwiched and fixed between the dashboard 1 and the front windshield 2 of the vehicle, the fixing section 41 is adjusted depending on the included angle and is then fixed in position.

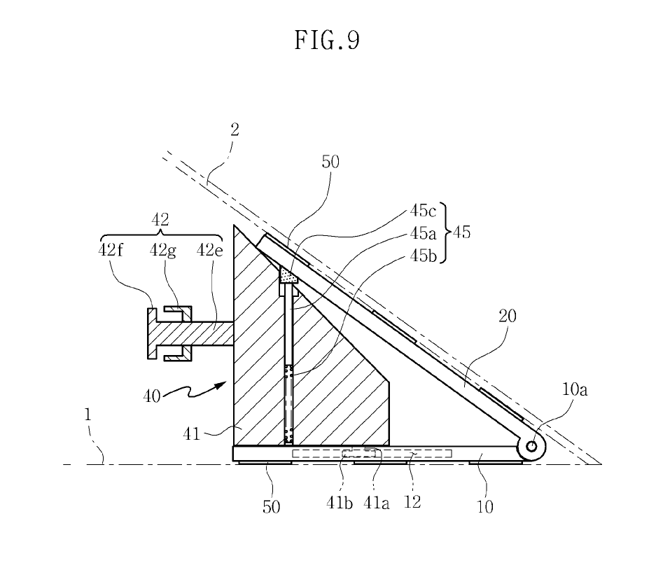

Referring to FIG. 9, the device holding member 40 may also include a position fixing section 45, which fixes or releases the fixing member 41 to or from the adjusted position.

The position fixing section 45 includes a position fixing bar 45a, which is coupled to the fixing bar 41 such that it is displaceable up and down. The position fixing bar 45a protrudes from the upper portion of the fixing bar 41.

The position fixing section 45 also includes a position fixing spring 45b disposed inside the fixing section 41. The position fixing spring 45b elastically supports the position fixing bar 45a.

It is preferred that an elastic support section 45c be provided on the upper end of the position fixing bar 45a. The elastic support section 45c is supported on the inner surface of the second support member 20.

The position fixing bar 45a is forced by the position fixing spring 45b such that it pushes the inner surface of the second support member 20 in the state in which the elastic support section 45c is abutted against the inner surface of the second support member 20, thereby fixing the position of the fixing section 41 between the first and second support members 10 and 20.

Since the position fixing bar 45a supports the opening of the interval between the first and second support members 10 and 20 by pushing the inner surface of the second support member 20, it serves to reinforce the fixing force of the fixing support member 30, so that the first and second support members 10 and 20 can be more firmly fixed between the dashboard 1 and the front windshield 2 of the vehicle.

The position fixing member 45 fixes the fixing member 41 independently of the open angle between the first and second support members 10 and 20, thereby enabling the user to freely adjust the position of the fixing section 41.

As set forth above, the media device mount of the invention is sandwiched and firmly fixed between the dashboard 1 and the front windshield 2 of the vehicle, so that the media device can be simply and securely affixed to the media device mount placed inside the vehicle.

In addition, the media device mount of the invention prevents the unnecessary formation of marks in the inside of the vehicle when the media device is affixed thereto, enables a variety of media devices to be simply mounted therein, and minimizes the portion of the front windshield 2 of the vehicle that is concealed thereby, thereby improving the vision of the driver.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for mounting a media device in a vehicle, comprising:
a first support member supported on an upper surface of a dashboard of the vehicle;
a second support member rotatably connected to the first support member, the second support member being supported on an inner surface of a front windshield of the vehicle;
a fixing support member that increases an interval between the first and second support members so that the first and second support members are fixed between the dashboard and the front windshield of the vehicle; and
a device holding member disposed between the first and second support members for mounting the media device.

2. The apparatus as set forth in claim 1, wherein the fixing support member comprises:
a movable block disposed between the first and second support members and supporting the interval between the first and second support members; and
a displacing section displacing the movable block back and forth between the first and second support members.

3. The apparatus as set forth in claim 2, wherein the movable block has an inclined surface, the inclined surface being inclined up against an inner surface of the second support member.

4. The apparatus as set forth in claim 2, wherein the fixing support member further comprises a block guide guiding a displacement of the movable block.

5. The apparatus as set forth in claim 4, wherein the first support member has a guide groove formed in the first support member, the guide groove extending in a direction in which the movable block is displaced, and the movable block has a guide protrusion protruding from a lower surface of the movable block, the guide protrusion being movably coupled to the guide groove.

6. The apparatus as set forth in claim 1, wherein the fixing support member comprises an elastic support section that provides an elastic support between the first and second support members.

7. The apparatus as set forth in claim 6, wherein the elastic support section comprises:
a support bar hinged to one of the first and second support members;
a movable guide bar hinged to the other one of the first support and second support members, the movable guide bar being movably coupled to the support bar; and
a support spring provided in the movable guide bar for elastically supporting the support bar.

8. The apparatus as set forth in claim 1, wherein the device holding member comprises:
a fixing section detachably disposed between the first and second support members; and
a holding section provided on the fixing section for holding the media device.

9. The apparatus as set forth in claim 8, wherein the fixing section is displaceable back and forth.

10. The apparatus as set forth in claim 8, wherein
the fixing section has a protrusion at a lower portion thereof, the protrusion having a holding rib on an outer surface of one end thereof, and
the first support member has a receiving section, one end of the protrusion is inserted into the receiving section, a displaceable receiving section is connected to the receiving section, the displaceable receiving section having a linear shape that extends in a forward or backward direction of the vehicle, such that the protrusion is displaced back and forth therein, and the holding rib remains in a state in which the holding rib is held in an upward direction when the protrusion is being displaced.

11. The apparatus as set forth in claim 8, wherein one side of the fixing section comprises an inclined surface, and the one side faces the second support member.

12. The apparatus as set forth in claim 8, wherein the second support member comprises a plurality of first teeth on an inner surface thereof, wherein the first teeth catch and fix one end of the fixing section.

13. The apparatus as set forth in claim 12, wherein one side of the fixing section comprises an inclined surface, the one side facing the second support member, and a plurality of second teeth provided on the inclined surface thereof, wherein the second teeth mesh with the first teeth.

14. The apparatus as set forth in claim 8, wherein the device holding member further comprises a position fixing section, the position fixing section fixing or releasing the fixing member to or from an adjusted position.

15. The apparatus as set forth in claim 14, wherein the position fixing section comprises:
a position fixing bar coupled to the fixing bar such that the position fixing bar is displaceable up and down, the position fixing bar protruding from an upper portion of the fixing bar; and
a position fixing spring disposed inside the fixing section, the position fixing spring elastically supporting the position fixing bar.

16. The apparatus as set forth in claim 15, wherein the position fixing section further comprises an elastic support section provided on an upper end of the position fixing bar, the elastic support section being supported on an inner surface of the second support member.
